(19) United States
(12) Patent Application Publication
(10) Pub. No.: US 2019/0217245 A1
(43) Pub. Date: Jul. 18, 2019

(54) MULTI-PLATE SCRUBBER

(71) Applicant: EMSOLUTION CO., Ltd., Gyeonggi-do (KR)

(72) Inventor: Hoon Min PARK, GYEONGGI-DO (KR)

(73) Assignee: EMSOLUTION CO., Ltd., Gyeonggi-do (KR)

(21) Appl. No.: 16/245,219

(22) Filed: Jan. 10, 2019

(30) Foreign Application Priority Data
Jan. 12, 2018 (KR) 10-2018-0004175

(51) Int. Cl. B01D 53/14; B01D 47/14

(52) U.S. Cl. CPC B01D 53/1487; B01D 47/024; B01D 2258/0283; B01D 47/14

(57) ABSTRACT

A multi-plate scrubber is provided, and more particularly, a multi-plate scrubber including plates having different shapes to purify polluting gas is provided. According to the multi-plate scrubber, the polluting gas is effectively purified by increasing chances of contact between the polluting gas and circulating water by using various plates having different shapes.

### CROSS-REFERENCE TO RELATED APPLICATION

This application claims the benefit of Korean Patent Application No. 10-2018-0004175, filed on Jan. 12, 2018, in the Korean Intellectual Property Office, the disclosure of which is incorporated herein in its entirety by reference.

### BACKGROUND

### 1. Field

One or more embodiments relate to a multi-plate scrubber, and more particularly, to a multi-plate scrubber purifying polluting gas by using plates having different shapes from each other.

### 2. Description of the Related Art

Polluting gas generated in a manufacturing process of products of electronics industry such as semiconductors, flat panel displays, solar cells or light-emitting diodes (LEDs), contains a volatile organic compound (VOC) and poly- and per-fluorinated compounds (PFCs) which are harmful gases. In particular, gases used in chemical deposition processes are highly toxic.

A device for purifying polluting gas as described above is referred to as a scrubber. A scrubber purifies polluting gas by heating the polluting gas or through water treatment in which the polluting gas is dissolved.

In a scrubber purifying polluting gas through water treatment, a porous packing called “PALL-RING” is typically used to increase contact between polluting gas and circulating water. The packing is easily polluted by byproducts generated during a process of purifying polluting gas, and the performance of the packing is easily degraded. Moreover, considerable decrease in the overall purification performance of polluting gas due to the packing clogged up by byproducts is also frequently caused.

A scrubber which purifies polluting gas through water treatment may also include a nozzle ejecting circulating water to increase contact between circulating water and polluting gas. In a scrubber in which a nozzle is used, the nozzle may be clogged up by byproducts generated in a process of purifying polluting gas, which lowers the efficiency of the scrubber, and the nozzle can be damaged depending on the degree of clogging.

Thus, the need for a scrubber that effectively purifies polluting gas without using a nozzle and a packing has increased.

### SUMMARY

One or more embodiments include a multi-plate scrubber that effectively performs water treatment on polluting gas.

Additional aspects will be set forth in part in the description which follows and, in part, will be apparent from the description, or may be learned by practice of the presented embodiments.

According to one or more embodiments, a multi-plate scrubber includes: a scrubber main body including a housing forming a closed space where polluting gas is purified, a circulating water inlet which is formed in the housing and through which circulating water flows in, and a polluting gas inlet which is formed in the housing and through which the polluting gas flows in; an overflow plate including a plurality of overflow pipes extending horizontally and having an open upper portion, from which the circulating water overflows to contact the polluting gas, the overflow plate being installed in the housing of the scrubber main body and; and a checking plate including a plurality of checking members protruding upwardly, arranged vertically downwards below spaces between the plurality of overflow pipes of the overflow plate, and extending horizontally, such that the circulating water overflowing from the plurality of overflow pipes of the overflow plate and falling downwards collides with the checking members to be spread, wherein the checking plate is installed in the housing of the scrubber main body below the overflow plate.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view of a multi-plate scrubber according to an embodiment of the present disclosure;

FIG. 2 is a perspective view of an overflow plate of the multi-plate scrubber illustrated in FIG. 1;

FIG. 3 is a perspective view of a checking plate of the multi-plate scrubber illustrated in FIG. 1;

FIG. 4 is a perspective view of a bubble plate of the multi-plate scrubber illustrated in FIG. 1;

FIG. 5 is a perspective view of an inclination plate of the multi-plate scrubber illustrated in FIG. 1;

FIG. 6 is a perspective view of a bubble plate that may be used in another embodiment of the present disclosure;

FIG. 7 is a perspective view of a bubble plate that may be used in another embodiment of the present disclosure; and

FIG. 8 is a cross-sectional view of the bubble plate illustrated in FIG. 7, taken along line VIII-VIII.

### DETAILED DESCRIPTION

Hereinafter, a multi-plate scrubber according to the present disclosure will be described in detail with reference to the attached drawings.

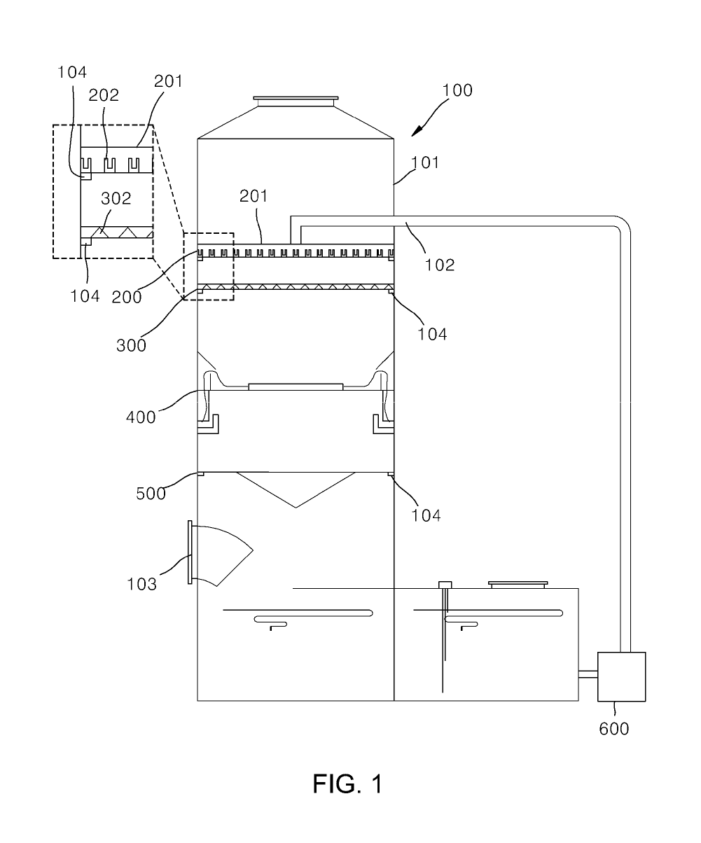

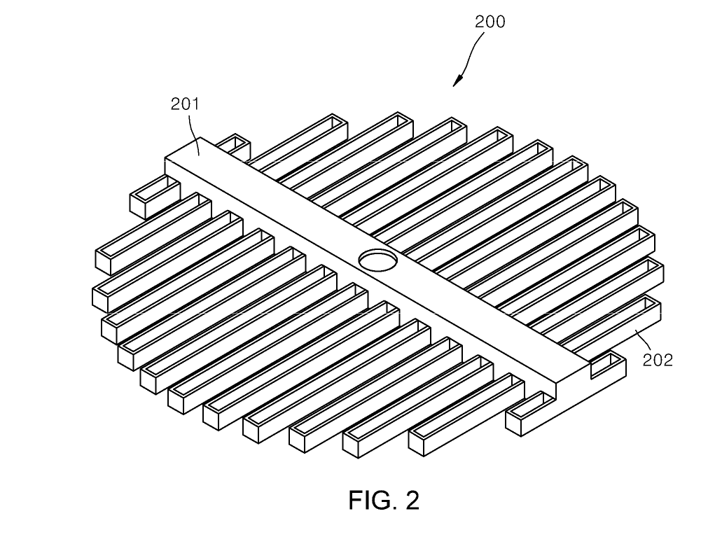

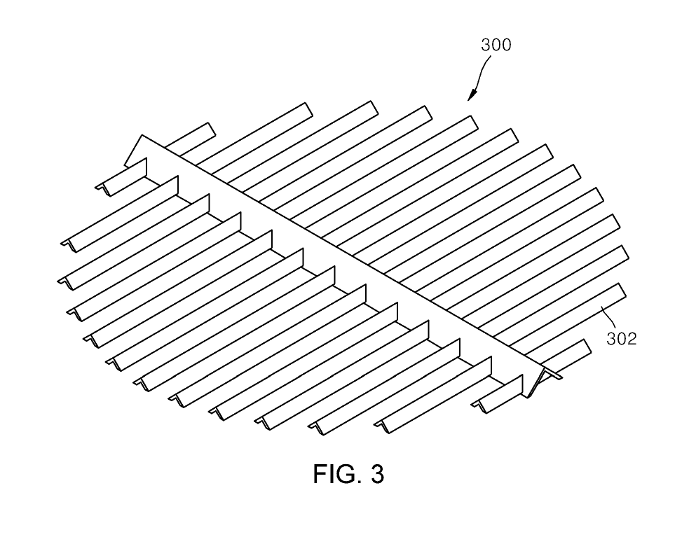

FIG. 1 is a cross-sectional view of a multi-plate scrubber according to an embodiment of the present disclosure. FIG. 2 is a perspective view of an overflow plate 200 of the multi-plate scrubber illustrated in FIG. 1. FIG. 3 is a perspective view of a checking plate 300 of the multi-plate scrubber illustrated in FIG. 1.

Referring to FIG. 1, the multi-plate scrubber according to the present embodiment includes a scrubber main body 100, an overflow plate 200, a checking plate 300, a bubble plate 400, and an inclination plate 500.

The scrubber main body 100 includes a housing 101, a circulating water inlet 102, and a polluting gas inlet 103.

The housing 101 has a closed space in which polluting gas and circulating water meet to purify the polluting gas. The plates, that is, the overflow plate 200, the checking plate 300, the bubble plate 400, and the inclination plate 500 of the multi-plate scrubber according to the present embodiment are mounted in the housing 101. A holding portion 104, on which the overflow plate 200, the checking plate 300, the bubble plate 400, and the inclination plate 500 are installed, protrudes inwardly into the housing 101 to be formed inside the housing 101. The circulating water inlet 102 is formed in an upper portion of the housing 101. The polluting gas inlet 103 is formed in a lower portion of the housing 101.

As illustrated in FIG. 2, the overflow plate 200 includes a supply pipe 201 and a plurality of overflow pipes 202. Referring to FIG. 1, the overflow plate 200 is installed in the housing 101 of the scrubber main body 100. The overflow plate 200 is installed in the housing 101 of the scrubber main body 100 by being held on the holding portion 104 protruding inwardly into the housing 101 to be formed in the housing 101.

In the multi-plate scrubber according to the present embodiment, the supply pipe 201 is connected to the circulating water inlet 102 of the scrubber main body 100. The supply pipe 201 has a closed pipe shape through which circulating water flows. Referring to FIG. 2, a plurality of overflow pipes 202 extend horizontally. That is, the plurality of overflow pipes 202 extend perpendicular to an extension direction of the supply pipe 201. The plurality of overflow pipes 202 are respectively connected to the supply pipe 201. The plurality of overflow pipes 202 are arranged in parallel to each other at certain distances, and an open space is formed between the overflow pipes 202. Each of the overflow pipes 202 has an opened upper portion. Circulating water that overflows from the overflow pipes 202 falls onto the empty space (open space) between the overflow pipes 202, and also, polluting gas that has flown in through the polluting gas inlet 103 flows into the empty space between the overflow pipes 202.

The checking plate 300 includes a plurality of checking members 302. Referring to FIG. 1, the checking plate 300 is spaced apart downwards from the overflow plate 200 and is installed in the housing 101 of the scrubber main body 100. The checking plate 300 is installed in the housing 101 of the scrubber main body 100 by being held on the holding portion 104 protruding inwardly into the housing 101 to be formed in the housing 101.

Referring to FIGS. 1 and 3, the plurality of checking members 302 extend in a same direction as the overflow pipes 202 of the overflow plate 200. The plurality of checking members 302 are arranged in parallel to each other at certain distances. The plurality of checking members 302 are arranged vertically downwards below the open spaces between the overflow pipes 202 of the overflow plate 200. As described above, as the plurality of overflow pipes 202 of the overflow plate 200 are arranged in parallel to each other at certain distances, an open space is formed between the plurality of overflow pipes 202. Referring to FIG. 1, the plurality of checking members 302 of the checking plate 300 are arranged vertically downwards below the open spaces between the overflow pipes 202. An open space is also formed between the checking members 302, like those between the overflow pipes 202. Circulating water falls through this open space, and polluting gas enters through this open space. Referring to FIG. 3, in the multi-plate scrubber according to the present embodiment, the checking members 302 have a cross-sectional shape tapering upwardly with respect to an extension direction thereof.

The bubble plate 400 includes a reservoir portion 401, a plurality of air pipes 402, a discharging portion 403, and a discharge barrier 404. Referring to FIG. 1, the bubble plate 400 of the multi-plate scrubber according to the present embodiment is disposed below the checking plate 300 to be installed in the housing 101 of the scrubber main body 100. The bubble plate 400 is installed in the housing 101 of the scrubber main body 100 by being held on the holding portion 104 protruding inwardly into the housing 101 to be formed in the housing 101.

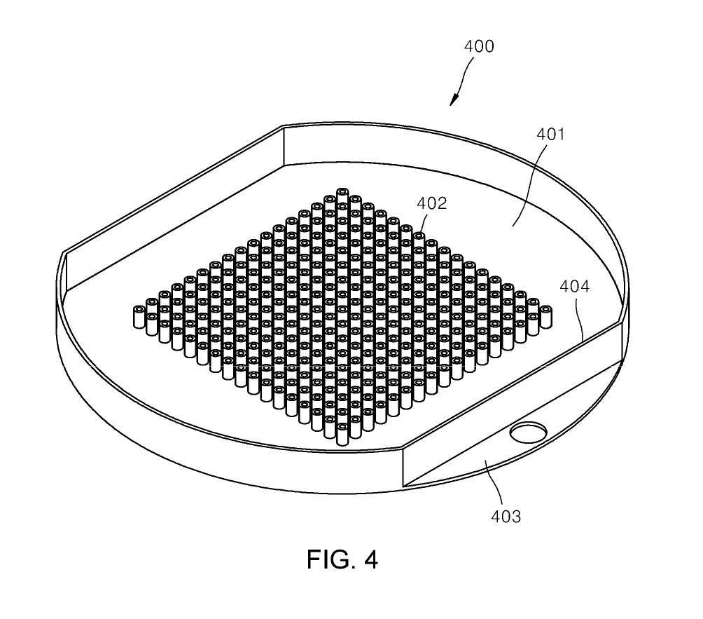

Referring to FIG. 4, the reservoir portion 401 is in the form of a container to temporarily store circulating water that has fallen from the checking plate 300. A plurality of air pipes 402 are formed in the reservoir portion 401. Each of the air pipes 402 protrudes upwardly with respect to a lower surface of the reservoir portion 401. Each of the air pipes 402 has a hole passing through vertically with respect to a protruding direction thereof. The discharging portion 403 is spaced apart from the reservoir portion 401. A hole is formed in a lower portion of the discharging portion 403 such that circulating water may be discharged through the hole. The discharge barrier 404 protrudes upwardly with respect to the lower surface of the reservoir portion 401 between the discharging portion 403 and the reservoir portion 401. The reservoir portion 401 and the discharging portion 403 are partitioned by the discharge barrier 404. Referring to FIG. 4, like the air pipes 402, the discharge barrier 404 also protrudes upwardly with respect to the reservoir portion 401, and the discharge barrier 404 has a higher height than the air pipes 402.

The inclination plate 500 includes an inclined surface 501, a plurality of inclination holes 502, and a plurality of guide flanges 503. Referring to FIG. 1, the inclination plate 500 is arranged below the bubble plate 400 and installed in the housing 101 of the scrubber main body 100. The inclination plate 500 is installed in the housing 101 of the scrubber main body 100 by being held on the holding portion 104 protruding inwardly into the housing 101 to be formed in the housing 101.

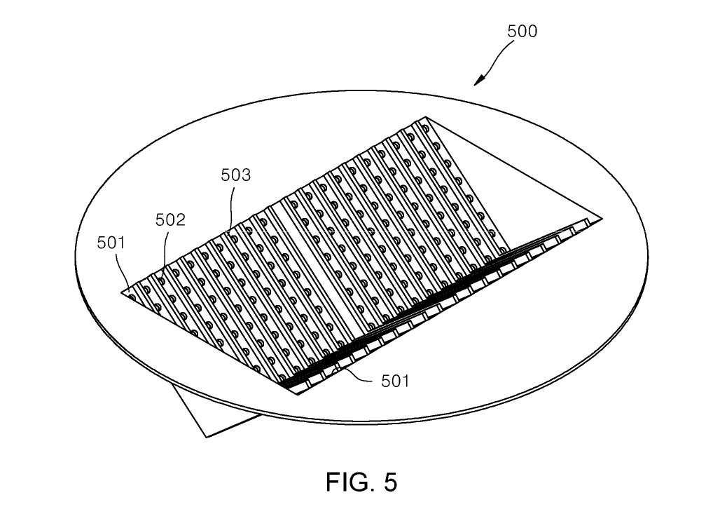

The inclined surface 501 has a form that is inclined downwards. Referring to FIG. 5, two inclined surfaces 501 are provided in the multi-plate scrubber according to the present embodiment. The two inclined surfaces 501 are arranged to face each other to be connected to each other at an end of each of the inclined surfaces 501. The plurality of inclination holes 502 are formed in the inclined surfaces 501. The plurality of inclination holes 502 are formed in the inclined surfaces 501 such that polluting gas may flow in through the inclination holes 502. The guide flanges 503 protrude from an upper surface of the inclined surfaces 501, and extend in an inclination direction of the inclined surfaces 501. A plurality of guide flanges 503 are formed on the inclined surfaces 501 at certain distances. The guide flanges 503 guide circulating water to flow in the inclination direction of the inclined surfaces 501.

An operation of purifying polluting gas by using the multi-plate scrubber according to the present embodiment configured as described above will be described.

Circulating water flows in through the circulating water inlet 102 of the scrubber main body 100. The circulating water that has entered through the circulating water inlet 102 is transferred to the supply pipe 201 of the overflow plate 200. The circulating water transferred to the supply pipe 201 flows in an extension direction of the supply pipe 201, and is moved to the plurality of overflow pipes 202 connected to the supply pipe 201. The circulating water moved to the plurality of overflow pipes 202 flows in an extension direction of the plurality of overflow pipes 202. When the circulating water is fully filled in each of the overflow pipes 202, the circulating water overflows above the overflow pipes 202. The overflowing circulating water falls onto the open spaces between the overflow pipes 202.

Meanwhile, polluting gas flows in through the polluting gas inlet 103 of the scrubber main body 100. The polluting gas inlet 103 is formed in the lower portion of the housing 101 of the scrubber main body 100, and thus, the polluting gas that has flown in through the polluting gas inlet 103 flows to the lower portion of the housing 101 of the scrubber main body 100. The polluting gas that has entered rises upwards inside the housing 101. The polluting gas risen up to the overflow plate 200 at an uppermost end of the housing 101 flows through between the plurality of overflow pipes 202.

As described above, the circulating water overflowing from the overflow pipes 202 falls onto the empty space (open space) between the overflow pipes 202, and polluting gas also flows into the empty space between the overflow pipes 202. Accordingly, the circulating water overflowing from the overflow pipes 202 and the polluting gas come into contact with each other in the empty space between the overflow pipes 202.

The circulating water overflowing from the overflow pipes 202 falls onto the checking plate 300 located below the overflow plate 200. The checking members 302 of the checking plate 300 are arranged vertically downwards from the empty space (open space) between the overflow pipes 202. Thus, the circulating water overflowing from the overflow pipes 202 falls onto the checking members 302 of the checking plate 300. As described above, the checking members 302 have an upwardly tapering cross-section, and thus, the circulating water that has fallen onto the checking members 302 is spread to both sides of each of the checking members 302. Here, the polluting gas is purified as the polluting gas that has flown into the housing 101 contacts with the circulating water that has fallen onto the checking members 302 to be spread. The circulating water fallen onto the checking members 302 to be spread is discharged through the empty space between the checking members 302 and falls by gravity.

The circulating water fallen on the checking members 302 to be spread generates a similar effect as ejecting circulating water through a nozzle. When the circulating water is spread via the checking members 302, an area of contact of the circulating water is increased. Accordingly, the polluting gas may be brought into contact with the circulating water more efficiently to be purified.

The circulating water discharged from the checking plate 300 falls onto the reservoir portion 401 of the bubble plate 400 installed in the housing 101 below the checking plate 300. The circulating water fallen onto the reservoir portion 401 is filled in the reservoir portion 401 until a discharge water level is reached. The discharge water level is equal to a height of the discharge barrier 404. As the circulating water continuously falls onto the reservoir portion 401 so that a level of the circulating water is higher than the height of the discharge barrier 404, the circulating water of the reservoir portion 401 flows over the discharge barrier 404 into the discharging portion 403. The circulating water moved to the discharging portion 403 is discharged through the hole in the lower portion of the discharging portion 403.

Meanwhile, polluting gas flows in through the air pipes 402 formed in the reservoir portion 401. The polluting gas that has flown into the air pipes 402 generates bubbles in circulating water stored in the reservoir portion 401. As described above, as the air pipes 402 have a shape protruding upwardly with respect to the reservoir portion 401, when a water level of the circulating water stored in the reservoir portion 401 is higher than a height of the air pipes 402, bubbles start to form in the circulating water. The bubbles facilitate contact between the circulating water and the polluting gas, thereby purifying the polluting gas that is in contact with the circulating water.

The circulating water discharged from the bubble plate 400 falls onto the inclination plate 500 installed in the housing 101 below the bubble plate 400. The circulating water that has fallen onto the inclination plate 500 flows along the inclined surfaces 501 of the inclination plate 500. The circulating water flows in the inclination direction of the inclined surface 501 via the plurality of guide flanges 503 formed on the inclined surface 501. The polluting gas flows in through the plurality of inclination holes 502 formed in the inclined surfaces 501 to come into contact with the circulating water flowing along the inclined surfaces 501. As circulating water flowing along the inclined surfaces 501 is discharged through the inclination holes 502 or as the polluting gas flows in through the inclination holes 502, chances of contact between the polluting gas and the circulating water are increased. In addition, as the inclination plate 500 includes the inclined surfaces 501, more inclination holes 502 may be formed in the inclined surfaces 501 than in a horizontal plate. The chances of contact between the circulating water and the polluting gas may also be increased by increasing an area, over which the circulating water flows, by using the inclined surfaces 501.

As described above, in the multi-plate scrubber according to the present embodiment, the two inclined surfaces 501 of the inclination plate 500 are arranged to face each other and are connected at the end of each of the inclined surfaces 501. Thus, the circulating water flowing along each inclined surface 501 is gathered at the end of the inclined surfaces 501, and then is discharged downwards through the inclination holes 502 formed in the end of the inclined surfaces 501.

The circulating water discharged from the inclination plate 500 is gathered in the lower portion of the housing 101 of the scrubber main body 100. The circulating water gathered in the lower portion of the housing 101 is moved into the circulating water inlet 102 formed in the upper portion of the housing 101 through a circulation pump 600 that is provided additionally.

In the multi-plate scrubber according to the present embodiment, circulating water sequentially passes the overflow plate 200, the checking plate 300, the bubble plate 400, and the inclination plate 500, and is then moved back to the overflow plate 200 via the circulation pump 600. In other words, the circulating water is circulated continuously.

As described above, according to the multi-plate scrubber of the present disclosure, polluting gas may be efficiently purified by increasing the chances of contact between polluting gas and circulating water by using the plates, that is, the overflow plate 200, the checking plate 300, the bubble plate 400, and the inclination plate 500 which have different shapes from each other. In addition, as the overflow plate 200, the checking plate 300, the bubble plate 400, and the inclination plate 500 are installed by being held on the holding portion 104 protruding into the housing 101, a contaminated plate or a plate having degrading performance may be easily replaced.

While the present disclosure has been described with reference to preferred embodiments, the scope of the present disclosure is not limited to the above-described embodiments.

For example, the overflow plate 200, the checking plate 300, the bubble plate 400, and the inclination plate 500 described above may be modified in various manners. In addition, an arrangement and a number of plates installed in the housing 101 of the scrubber main body 100 may also be various.

While the overflow plate 200 is described above to include the supply pipe 201 as illustrated in FIG. 2 and receive circulating water through the supply pipe 201 including the plurality of overflow pipes 202 connected to the circulating water inlet 102, an overflow plate without a supply pipe may also be configured. In this case, circulating water that has flown in through a circulating water inlet falls onto a plurality of overflow pipes to be supplied to the plurality of overflow pipes.

In addition, while the supply pipe 201 is described above as having a closed pipe shape such that circulating water flows therethrough, a supply pipe may have other various shapes. For example, a supply pipe having an opened upper surface may be configured. In this case, the supply pipe may have a semicircular cross-section.

In addition, while the inclination plate 500 is described above as including the guide flanges 503, an inclination plate without a guide flange may also be configured. In this case, circulating water flowing along an inclined surface of the inclination plate may flow not just in an inclination direction of the inclined surface, but may flow in any direction on the inclined surface.

In addition, while the inclination plate 500 is described above as including two inclined surfaces 501, an inclination plate having one inclined surface or three or more inclined surfaces may also be configured.

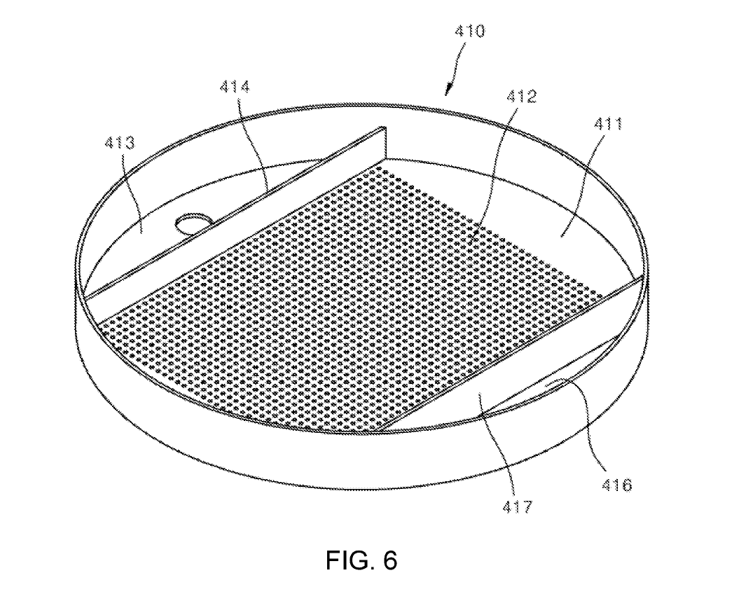

In addition, the bubble plate 400 may also have other various shapes. While the multi-plate scrubber including the bubble plate 400 having the structure illustrated in FIG. 4 is described above as an example, a multi-plate scrubber including a bubble plate 410 having a structure as illustrated in FIG. 6 may also be configured.

Referring to FIG. 6, the bubble plate 410 may be configured to directly receive circulating water from a circulating water inlet of a scrubber main body. The bubble plate 410 illustrated in FIG. 6 may further include a storage unit 416 and a supply barrier 417, and a plurality of air pipes 412 may be configured not to protrude. A discharging portion 413 and a discharge barrier 414 of the bubble plate 410 are identical to the discharging portion 403 and the discharge barrier 404 of the bubble plate 400 illustrated in FIG. 4. Circulating water that has flown in through the circulating water inlet is stored in the storage unit 416 of the bubble plate 410. When the circulating water stored in the storage unit 416 reaches a supply water level, the circulating water flows over the supply barrier 417 which protrudes from a lower surface of a reservoir portion 411 between the storage unit 416 and the reservoir portion 411 to be supplied to the reservoir portion 411.

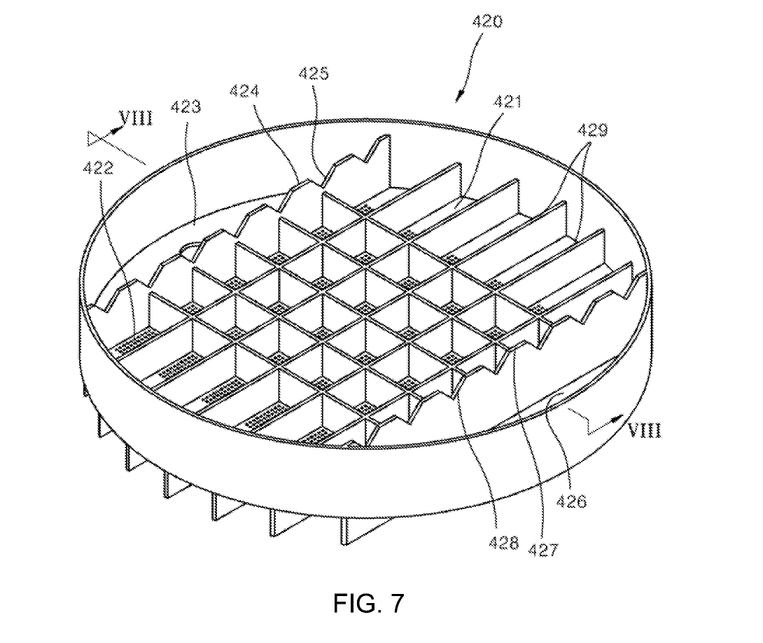

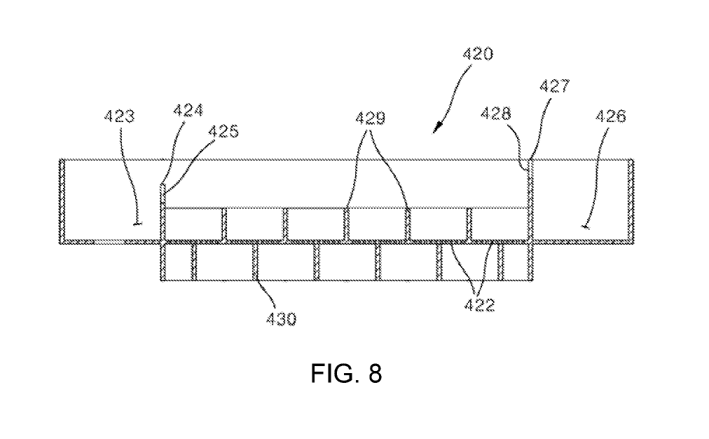

In addition, a multi-plate scrubber including a bubble plate 420 having a structure as illustrated in FIG. 7 may also be configured. FIG. 8 is a cross-sectional view of the bubble plate 420 illustrated in FIG. 7, taken along line VIII-VIII.

The bubble plate 420 illustrated in FIG. 7 and FIG. 8 includes a reservoir portion 421, a plurality of air pipes 422, a discharging portion 423, a discharge barrier 424, a supply groove 428, a storage portion 426, a supply barrier 427, a discharge groove 425, a first division barrier 429, and a second division barrier 430, and the plurality of air pipes 422 are configured to not protrude. The reservoir portion 421, the plurality of air pipes 422, the discharging portion 423, and the discharge barrier 424 of the bubble plate 420 illustrated in FIG. 7 respectively perform same functions as the reservoir portion 401, the plurality of air pipes 402, the discharging portion 403, and the discharge barrier 404 of the bubble plate 400 illustrated in FIG. 4. The first division barrier 429 is formed to protrude upwardly from a lower surface of the reservoir portion 421. The first division barrier 429 is used to partition an upper space of the reservoir portion 421 into a lattice shape. The second division barrier 430 is formed to protrude downwards with respect to the reservoir portion 421. In respect of heights of the supply barrier 427, the discharge barrier 424, and the first division barrier 429 with respect to the lower surface of the reservoir portion 421, the supply barrier 427 has a highest height, and the first division barrier 429 has a lowest height. Accordingly, circulating water flowing over the supply barrier 427 may be easily moved to the discharging portion 423 due to a height of the discharge barrier 424 which is lower than that of the supply barrier 427. Thus, the circulating water may continuously flow from the reservoir portion 421 to the discharging portion 423. The second division barrier 430 is used to partition a lower space of the reservoir portion 421 into a lattice shape. Referring to FIG. 8, a position where the first division barrier 429 is formed and a position where the second division barrier 430 is formed are not symmetrical with respect to the reservoir portion 421. That is, the second division barrier 430 is formed to protrude from the lower surface of the reservoir portion 421 at a position spaced apart from the position where the first division barrier 429 is formed. A plurality of supply grooves 428 are formed in the supply barrier 427 at certain distances, and a plurality of discharge grooves 425 are formed in the discharge barrier 424 at certain distances.

The bubble plate 420 configured as described above may store circulating water in each independent space via the first division barrier 429, thereby uniformly purifying polluting gas. In addition, due to the arrangement of the first division barrier 429 and the second division barrier 430 as described above, polluting gas does not directly flow into the air pipes 422. Due to an alternate arrangement of the first division barrier 429 and the second division barrier 430, polluting gas flows into the air pipes 422 while being bent. This extends a path of the polluting gas, thereby increasing the chances of contact with the circulating water. The supply grooves 428 facilitate the flow of circulating water supplied from the storage portion 426 to the reservoir portion 421, and the discharge grooves 425 facilitate the flow of circulating water discharged from the reservoir portion 421 to the discharging portion 423.

Next, modification of the arrangement and number of plates installed in a housing of a scrubber main body will be described.

While one overflow plate 200 and one checking plate 300 are described above as being installed in the housing 101, several overflow plates and several checking plates may also be installed in a housing. For example, an overflow plate and a checking plate may be configured as a set, and two sets each including an overflow plate and a checking plate may be installed in a housing. In this case, the sets including overflow plates and checking plates may be arranged such that an extension direction of overflow pipes and checking members of a set mounted in an upper portion is orthogonal to an extension direction of overflow pipes and checking members of a set that is mounted in a lower portion.

In addition, while the overflow plate 200, the checking plate 300, the bubble plate 400, and the inclination plate 500 are described above as being sequentially arranged inside the housing 101 in an order from an upper portion, a bubble plate, an overflow plate, a checking plate, and an inclination plate may also be sequentially arranged in an order from an upper portion. Alternatively, in an order from an upper portion, a bubble plate, an overflow plate, a checking plate, and again a bubble plate may be sequentially arranged, thus installing two bubble plates. In other words, the arrangement and number of plates may be variously modified according to a type of polluting gas and a given circumstance.

In addition, while the multi-plate scrubber including the overflow plate 200, the checking plate 300, the bubble plate 400, and the inclination plate 500 is described above, a multi-plate scrubber including only an overflow plate and a checking plate may also be configured, or a multi-plate scrubber including only an overflow plate, a checking plate, and a bubble plate may also be configured.

In addition, while the plates, that is, the overflow plate 200, the checking plate 300, the bubble plate 400, and the inclination plate 500, are described above as being installed by being held on the holding portion 104 formed in the housing 101, the plates may be installed in a housing by using other various methods.

According to the multi-plate scrubber of the present disclosure, the chances of contact between polluting gas and circulating water may be increased by using various plates having different shapes, thereby effectively purifying polluting gas.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A multi-plate scrubber comprising:
a scrubber main body comprising a housing forming a closed space where polluting gas is purified, a circulating water inlet which is formed in the housing and through which circulating water flows in, and a polluting gas inlet which is formed in the housing and through which the polluting gas flows in;
an overflow plate comprising a plurality of overflow pipes extending horizontally and having an open upper portion, from which the circulating water overflows to contact the polluting gas, the overflow plate being installed in the housing of the scrubber main body and; and
a checking plate comprising a plurality of checking members protruding upwardly, arranged vertically downwards below the spaces between the plurality of overflow pipes of the overflow plate, and extending horizontally, such that the circulating water overflowing from the plurality of overflow pipes of the overflow plate and falling downwards collides with the checking members to be spread, wherein the checking plate is installed in the housing of the scrubber main body below the overflow plate.

2. The multi-plate scrubber of claim 1, wherein the overflow plate further comprises a supply pipe through which the circulating water is received from the circulating water inlet of the scrubber main body and supplied to the plurality of overflow pipes.

3. The multi-plate scrubber of claim 1, wherein the plurality of overflow pipes of the overflow plate are arranged in parallel to each other at certain distances, and
the plurality of checking members of the checking plate are arranged in parallel to each other at certain distances.

4. The multi-plate scrubber of claim 3, wherein the plurality of overflow pipes of the overflow plate and the plurality of checking members of the checking plate extend in parallel to each other, and
the plurality of checking members of the checking plate are respectively arranged vertically downwards below the spaces between the plurality of overflow pipes of the overflow plate.

5. The multi-plate scrubber of claim 4, wherein a plurality of sets each including the overflow plate and the checking plate are provided, and
an extension direction of a plurality of overflow pipes and a plurality of checking members of the overflow plate and the checking plate included in any one of the plurality of sets is arranged to cross an extension direction of a plurality of overflow pipes and a plurality of checking members of an overflow plate and a checking plate included in another adjacent set.

6. The multi-plate scrubber of claim 1, further comprising an inclination plate including an inclined surface that is inclined such that the circulating water flows along the inclined surface, and a plurality of inclination holes formed in the inclined surface such that the polluting gas is brought into contact with the circulating water flowing along the inclined surface, the inclination plate being installed in the housing of the scrubber main body.

7. The multi-plate scrubber of claim 6, wherein the inclination plate further comprises a plurality of guide flanges protruding from an upper surface of the inclined surface to extend along an inclination direction so as to guide the flow of the circulating water flowing along the inclined surface.

8. The multi-plate scrubber of claim 1, further comprising a bubble plate including a reservoir portion storing the circulating water, a plurality of air pipes formed in the reservoir portion such that the polluting gas is discharged through the air pipes, a discharging portion through which the circulating water is discharged, and a discharge barrier protruding upwardly with respect to a lower surface of the reservoir portion between the reservoir portion and the discharging portion such that the circulating water that has been stored in the reservoir portion and has reached a discharge water level flows to the discharging portion, wherein the bubble plate is installed in the housing of the scrubber main body.

9. The multi-plate scrubber of claim 8, wherein the plurality of air pipes of the bubble plate protrude upwardly with respect to the lower surface of the reservoir portion.

10. The multi-plate scrubber of claim 8, wherein the bubble plate further comprises a storage portion, to which the circulating water is supplied from the circulating water inlet of the scrubber main body, and a supply barrier protruding upwardly with respect to the lower surface of the reservoir portion between the reservoir portion and the storage portion such that the circulating water that is supplied to the storage portion and has reached a supply water level flows to the reservoir portion.

11. The multi-plate scrubber of claim 10, wherein the bubble plate further comprises a first division barrier protruding upwardly with respect to the lower surface of the reservoir portion to partition the reservoir portion into a lattice shape,
wherein the supply barrier of the bubble plate includes a plurality of supply grooves formed in the supply barrier such that the circulating water flows to the reservoir portion, and
the discharge barrier of the bubble plate includes a plurality of discharge grooves formed in the discharge barrier such that the circulating water flows to the discharging portion.

12. The multi-plate scrubber of claim 11, wherein the supply barrier of the bubble plate protrudes more upwardly with respect to the lower surface of the reservoir than the discharge barrier,
wherein the discharge barrier of the bubble plate protrudes more upwardly with respect to the lower surface of the reservoir portion than the first division barrier.

13. The multi-plate scrubber of claim 11, wherein the bubble plate further comprises a second division barrier protruding downwards with respect to the lower surface of the reservoir portion at a position spaced apart from the first division barrier.
